(19) United States
(12) Patent Application Publication
(10) Pub. No.: US 2022/0388519 A1
(43) Pub. Date: Dec. 8, 2022

(54) METHOD, COMPUTING DEVICE AND COMPUTER-READABLE MEDIUM FOR DIVIDING AND PROVIDING WORK TO WORKERS IN CROWDSOURCING

(71) Applicant: SELECT STAR, INC., Daejeon (KR)

(72) Inventor: Mun Hwi JEON, Seoul (KR)

(21) Appl. No.: 17/727,773

(22) Filed: Apr. 24, 2022

(30) Foreign Application Priority Data
Jun. 4, 2021 (KR) 10-2021-0072768

(51) Int. Cl. B60W 40/09; G07C 5/00; G07C 5/08

(52) U.S. Cl. CPC B60W 40/09; G07C 5/008; G07C 5/0833; B60W 2540/21; B60W 2554/4049; B60W 2420/54; B60W 2420/42

(57) ABSTRACT

The present invention relates to a method, a computing device and a computer-readable medium for dividing and providing a work to workers in crowdsourcing, and more particularly, to a method, a computing device and a computer-readable medium for dividing and providing a work to workers in crowdsourcing, in which, when a work is provided to workers in crowdsourcing, the work is segmented into a plurality of zones, and the work segmented into the zones is provided to a plurality of workers to allow the workers to perform tasks for specific zones of the work, respectively, so that a large-scale work is rapidly processed.

### BACKGROUND OF THE INVENTION

### 1. Field of the Invention

The present invention relates to a method, a computing device and a computer-readable medium for dividing and providing a work to workers in crowdsourcing, and more particularly, to a method, a computing device and a computer-readable medium for dividing and providing a work to workers in crowdsourcing, in which, when a work is provided to workers in crowdsourcing, the work is segmented into a plurality of zones, and the work segmented into the zones is provided to a plurality of workers, to allow the workers to perform tasks for specific zones of the work, respectively, so that a large-scale work is rapidly processed.

### 2. Description of the Related Art

Recently, as technology development related to artificial intelligence is actively conducted, the importance of technology that constructs data for learning artificial intelligence is also emerging. Since the artificial intelligence, especially deep learning-based artificial intelligence exhibits the better performance when quantity and quality of learning data are excellent, constructing high-quality learning data is an important factor in the development of artificial intelligence.

For constructing the learning data, recently, methods for constructing learning data based on crowdsourcing have been used. The crowdsourcing refers to a scheme in which works such as images, videos, audios and texts are provided to an unspecified number of workers, the workers perform tasks such as a kind of labeling on the works, task results performed by the workers are provided to a plurality of reviewers and reviewed by the reviewers, and learning data is constructed based on the works that have passed the reviews.

Specifically, the workers are provided with one work through crowdsourcing, and perform one or more unit tasks for the corresponding work. For example, the worker is provided with one image corresponding to one work, sets an area of a specific object corresponding to a unit task in the image, and performs the unit task of identifying the set specific object, thereby outputting work results.

However, the conventional method of providing a work to workers through crowdsourcing is conducted in a manner that one work is distributed to one worker. Thus, in the case of large-scale work, the task execution time of the worker assigned to the work may increase. In addition to simply increasing the working time, the quality of task results may be deteriorated, since the concentration level of the worker decreases as the scale of the work increases.

The above problems do not match the original purpose of the crowdsourcing-based learning data construction approach used to secure a predetermined level of quality while improving the working speed by dividing data labeling tasks through a plurality of users.

Meanwhile, Korean Patent Registration No. 10-2008095 (METHOD AND SYSTEM FOR MANAGING SPATIAL CROWDSOURCING TASK BASED ON PRIVACY-AWARE GRID. Registered on Jul. 31, 2019) discloses a configuration in which one task is divided in a grid form and the divided grid cells are assigned to participants. However, according to the above technology, because one task is completely divided and the divided pieces are assigned to the participants, an object lying a boundary between a plurality of pieces are divided, and accordingly, it is difficult to perform a task on the divided object. As a result, the task on the object located at the boundary between the divided pieces may be omitted.

Therefore, it is required to develop a novel method capable of dividing and providing a work to workers, but effectively solving the above-mentioned conventional problems in a method of constructing learning data through crowdsourcing.
(Patent Document 1) Korean Patent Registration No. 10-2008095 (METHOD AND SYSTEM FOR MANAGING SPATIAL CROWDSOURCING TASK BASED ON PRIVACY-AWARE GRID. Registered on Jul. 31, 2019)

### SUMMARY OF THE INVENTION

The present invention relates to a method, a computing device and a computer-readable medium for dividing and providing a work to workers in crowdsourcing, and more particularly, provides a method, a computing device and a computer-readable medium for dividing and providing a work to workers in crowdsourcing, in which, when a work is provided to workers in crowdsourcing, the work is segmented into a plurality of zones, and the work segmented into the zones is provided to a plurality of workers, to allow the workers to perform tasks for specific zones of the work, respectively, so that a large-scale work is rapidly processed.

In order to solve the above problem, one embodiment of the present invention provides a method for dividing and providing a work to workers in crowdsourcing performed on a computing device including at least one processor and at least one memory. The method includes: a zone segmentation step of segmenting a work including at least one unit task into a predetermined number of zones; a graphic-processing step of graphic-processing a specific zone to be assigned to a worker in the work segmented into the predetermined number of zones so as to be displayed differently from other zones; and a task interface providing step of providing a task interface including the work formed by graphic-processing the specific zone to a worker terminal of the worker, wherein the worker selects a task target area for an object through the worker terminal displaying the task interface, and the selecting of the task target area includes: selecting an area in which the object is completely included in the specific zone; and selecting an area in which a part of the object is included in the specific zone and a remainder of the object deviates from the specific zone in at least one direction according to a preset boundary rule from the specific area.

According to one embodiment of the present invention, the work may include image data including at least one image object, and the boundary rule may include: selecting an area in which a part of the object is included in the specific zone and a remainder of the image object deviates from the specific zone in a first direction of a horizontal axis of the image data; selecting an area in which a part of the object is included in the specific zone and a remainder of the image object deviates from the specific zone in a first direction of a vertical axis of the image data; and selecting an area in which a part of the object is included in the specific zone and a remainder of the image object deviates from the specific zone in the first direction of the horizontal axis and the first direction of the vertical axis of the image data.

According to one embodiment of the present invention, the work may include audio data including at least one audio object, the zone segmentation step may include segmenting the audio data into a predetermined number of zones according to a preset time interval, and the graphic-processing step may include graphic-processing a specific area to be assigned to a worker so as to be displayed differently from other zones in a waveform of the audio data visually displayed on an axis of time.

According to one embodiment of the present invention, the work may include audio data including at least one audio object, and the boundary rule may include selecting an area, in which a part of the object is included in the specific zone and a remainder of the audio object deviates from the specific zone in a first direction of the time axis of the audio data.

According to one embodiment of the present invention, the work may include text data including a plurality of unit texts, and the boundary rule may include selecting an area in which a part of the object is included in the specific zone and a remainder thereof deviates from the specific zone in a text progression direction of the text data.

In order to solve the above problems, one embodiment of the present invention provides a computing device including at least one processor and at least one memory to perform a method for dividing and providing a work to workers in crowdsourcing, which performs: a zone segmentation step of segmenting a work including at least one unit task into a predetermined number of zones; a graphic-processing step of graphic-processing a specific zone to be assigned to a worker in the work segmented into the predetermined number of zones so as to be displayed differently from other zones; and a task interface providing step of providing a task interface including the work formed by graphic-processing the specific zone to a worker terminal of the worker, wherein the worker is allowed to select a task target area for an object through the worker terminal displaying the task interface, and the selecting of the task target area includes: selecting an area in which the object is completely included in the specific zone; and selecting an area in which a part of the object is included in the specific zone and a remainder of the object deviates from the specific zone in at least one direction according to a preset boundary rule from the specific area.

In order to solve the above problems, one embodiment of the present invention provides a computer program stored on a computer-readable medium and including a plurality of instructions executed by at least one processor, which includes: a zone segmentation step of segmenting a work including at least one unit task into a predetermined number of zones; a graphic-processing step of graphic-processing a specific zone to be assigned to a worker in the work segmented into the predetermined number of zones so as to be displayed differently from other zones; and a task interface providing step of providing a task interface including the work formed by graphic-processing the specific zone to a worker terminal of the worker, wherein the worker is allowed to select a task target area for an object through the worker terminal displaying the task interface, and the selecting of the task target area includes: selecting an area in which the object is completely included in the specific zone; and selecting an area in which a part of the object is included in the specific zone and a remainder of the object deviates from the specific zone in at least one direction according to a preset boundary rule from the specific area.

According to one embodiment of the present invention, the work is segmented into a plurality of zones, the zones segmented on the work are assigned a plurality of workers to allow the workers to perform tasks for one work, so that the task can be rapidly performed.

According to one embodiment of the present invention, a task may be performed, based on a boundary rule, on an object having a part included in a specific zone and a remainder deviating from the specific zone, so that the worker performing task on a specific zone of the work can be prevented from missing a task on an object located over a plurality of boundaries of the work.

### BRIEF DESCRIPTION OF THE DRAWINGS

FIG. 1 schematically shows a system for establishing data in crowdsourcing way according to one embodiment of the present invention.

FIG. 2 schematically shows internal components of the computing device performing a method for dividing and providing a work to workers in crowdsourcing according to one embodiment of the present invention.

FIG. 3 schematically shows overall steps of the method for dividing and providing a work to workers in crowdsourcing according to one embodiment of the present invention.

FIGS. 4A and 4B schematically show a boundary rule for a work segmented into one-dimensional zones according to one embodiment of the present invention.

FIGS. 5A, 5B, and 5C schematically show a boundary rule for a work segmented into two-dimensional zones according to one embodiment of the present invention.

FIG. 6 schematically shows image data segmented into a plurality of zones in which tasks are performed for each zone according to one embodiment of the present invention.

FIG. 7 schematically shows audio data segmented into a plurality of zones in which tasks are performed for each zone according to one embodiment of the present invention.

FIG. 8 schematically shows text data segmented into a plurality of zones in which tasks are performed for each zone according to one embodiment of the present invention.

FIG. 9 schematically shows a process of processing data segmented into a plurality of zones according to one embodiment of the present invention.

FIG. 10 schematically shows internal components of the computing device according to one embodiment of the present invention.

### DETAILED DESCRIPTION OF THE INVENTION

Hereinafter, various embodiments and/or aspects will be described with reference to the drawings. In the following description, numerous specific details are set forth in order to provide a thorough understanding of one or more aspects for the purpose of explanation. However, it will also be appreciated by a person having ordinary skill in the art that such aspect(s) may be carried out without the specific details. The following description and accompanying drawings will be set forth in detail for specific illustrative aspects among one or more aspects. However, the aspects are merely illustrative, some of various ways among principles of the various aspects may be employed, and the descriptions set forth herein are intended to include all the various aspects and equivalents thereof.

In addition, various aspects and features will be presented by a system that may include a plurality of devices, components and/or modules or the like. It will also be understood and appreciated that various systems may include additional devices, components and/or modules or the like, and/or may not include all the devices, components, modules or the like recited with reference to the drawings.

The term “embodiment”, “example”, “aspect”, “exemplification”, or the like as used herein may not be construed in that an aspect or design set forth herein is preferable or advantageous than other aspects or designs. The terms ‘unit’, ‘component’, ‘module’, ‘system’, ‘interface’ or the like used in the following generally refer to a computer-related entity, and may refer to, for example, hardware, software, or a combination of hardware and software.

In addition, the terms “include” and/or “comprise” specify the presence of the corresponding feature and/or component, but do not preclude the possibility of the presence or addition of one or more other features, components or combinations thereof.

In addition, the terms including an ordinal number such as first and second may be used to describe various components, however, the components are not limited by the terms. The terms are used only for the purpose of distinguishing one component from another component. For example, the first component may be referred to as the second component without departing from the scope of the present invention, and similarly, the second component may also be referred to as the first component. The term “and/or” includes any one of a plurality of related listed items or a combination thereof.

In addition, in embodiments of the present invention, unless defined otherwise, all terms used herein including technical or scientific terms have the same meaning as commonly understood by those having ordinary skill in the art. Terms such as those defined in generally used dictionaries will be interpreted to have the meaning consistent with the meaning in the context of the related art, and will not be interpreted as an ideal or excessively formal meaning unless expressly defined in the embodiment of the present invention.

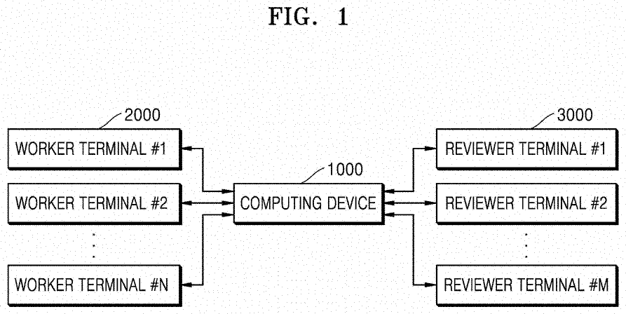

FIG. 1 schematically shows a system for establishing data in crowdsourcing manner according to one embodiment of the present invention.

As shown in FIG. 1, the system for constructing data, preferably, labeled learning data, in a crowdsourced manner includes a plurality of work terminals 2000 for performing tasks on the work, a plurality of reviewer terminals 3000 for reviewing task results performed by the workers, and a computing device 1000 communicating with the worker terminals 2000 and the reviewer terminals 3000.

The worker terminal 2000 communicates with the computing device 1000 to receive at one work on which tasks may be performed, and transmits a task result inputted by the worker on the corresponding work to the computing device 1000. Meanwhile, the worker terminal 2000 may display an interface for displaying the work to allow the worker to perform the task on the provided work, and the worker may input the work result on the work through the interface displayed on the worker terminal 2000.

Meanwhile, the worker may transmit the work result to the computing device 1000 through the worker terminal 2000, or may receive a predetermined reward from the computing device 1000 when reviews on the work result by multiple reviewers are completed after the work result is transmitted. Specifically, the computing device 1000 may provide a predetermined reward according to the work result to an account corresponding to the worker having provided the work result, and the worker terminal 2000 may display the reward provided to the corresponding account according to an input of the worker.

Meanwhile, regarding the predetermined reward, the size of the reward may be determined according to amounts of performed tasks on the work and reviewed results on the performed work result, and accordingly, the reward may be a motivation for enabling the workers to output high-quality work results. In addition, the worker may receive the predetermined reward only when the task result performed by the worker matches the correct answer inferred for the task result by the computing device 1000.

The reviewer terminal 3000 communicates with the computing device 1000 to receive one or more task results performed by a plurality of workers, and transmits the review results inputted by the reviewers on the corresponding task results to the computing device 1000. Meanwhile, the reviewer terminal 3000 may display an interface for displaying the task results so that the reviewer performs the review on the provided task results, and the reviewer may input the review result according to the review on the task results via the interface displayed on the reviewer terminal 3000.

Meanwhile, in another embodiment of the present invention, the reviewer in addition to the worker also may receive a predetermined reward from the computing device 1000 according to the review result performed by the reviewer. Specifically, only when the reviewed result by the reviewer for the task result is consistent with a correct answer inferred for the task result in the computing device 1000, the reviewer may receive a predetermined reward.

Accordingly, the inspector terminal 3000 and the reviewer terminal 3000 may include various types of computing devices, such as a smart phone and PC, capable of communicating with the computing device 1000 to display information and receive an input from a user. In addition, the inspector terminal 3000 and the reviewer terminal 3000 may be installed therein with a web browser capable of executing an application or web page for communicating with the computing device 1000, and the communication with the computing device 1000 may be performed by executing the application or the web page.

Meanwhile, the application or the web page may include a separate application or a separate web page for the workers, and a separate application or a separate web page for the reviewers. Whereas, the application or the web page may include an application or web page commonly used by both of the worker and the reviewer, and different information according to an account type may be displayed upon log-in with the account type corresponding to each of the worker and the reviewer.

The computing device 1000 may communicate with a plurality of worker terminals 2000 and a plurality of reviewer terminals 3000, so as to provide a work to the worker terminals 2000, thereby receiving task results and provide the task results to the reviewer terminals 3000, thereby receiving review results. Specifically, the computing device 1000 may provide a plurality of works included in a project or mission to the worker terminals 2000, and the works may include at least one unit task.

In other words, the project or mission may include a plurality of works (data) for generating labeled data such as artificial intelligence learning data, and the works may include image data, video data, audio data, text data, and the like. Meanwhile, each of the works includes at least one unit task such as a unit task for labeling a specific object.

Accordingly, the computing device 1000 provides multiple works included in the project or mission to the workers, and the workers output task results after performing the at least one unit task included in the provided works.

The computing device 1000 provides the task results performed by the workers to the reviewers, and the reviewers output review results after performing reviews on the provided task results. The computing device 1000 infers correct answers for the task results based on the review results performed by the multiple reviewers on the task results.

In addition, the computing device 1000 may provide a predetermined reward to a corresponding worker for the task result performed by the worker, or may provide a predetermined reward to a corresponding reviewer for the review result performed by the reviewer. Although the computing device 1000 in FIG. 1 is illustrated as a single computing device 1000 that is not physically separated, the computing device 1000 may include a plurality of physically separated detailed computing devices. For example, the computing device 1000 may include a first detailed computing device (not shown) including configurations of providing works to the worker terminals 2000 to receive task results from the worker terminals 2000, providing the task results to the reviewer terminals 3000 to receive review results from the reviewer terminals 3000, and providing predetermined rewards to the workers and the reviewers, respectively, and a second detailed computing device including a configuration for outputting inference results for the corresponding work results based on the received review results (not shown). In the above case, the first detailed computing device and the second detailed computing device may be physically separated, however, data can be exchanged through mutual communication. The computing device 1000, such as a server, may include various types of data processing devices capable of performing communication with the worker terminals 2000 and the reviewer terminals 3000 and outputting inference results according to the review results of the reviewers.

The computing device 1000 may serve to segment a work into a plurality of zones in crowdsourcing of the present invention, and provide the work segmented into the zones to workers.

In addition, according to the present invention, the work segmented into the zones by the computing device 1000 may include at least one object, and the unit task for the work may include a unit task of selecting an area of an object contained in the corresponding work, or assigning a specific value to the selected object after selecting the area of the object contained in the corresponding work. For example, the assigning of the specific value to the selected object may signify assigning a name, type or the like of the selected object.

Although not shown in FIG. 1, in another embodiment of the present invention, the computing device 1000 may communicate with a data requestor terminal (not shown) and receive a project or mission including works requiring labeling tasks which are requested by a data requestor through the data requestor terminal, and the data requestor terminal may receive the labeled work from the computing device 1000 according to the comprehensive result outputted based on the review result on the task results for the corresponding work. In addition, the work having a type required by the data requester may be pre-stored in the computing device 1000, and the data requestor terminal may receive the work labeled for the pre-stored work from the computing device 1000.

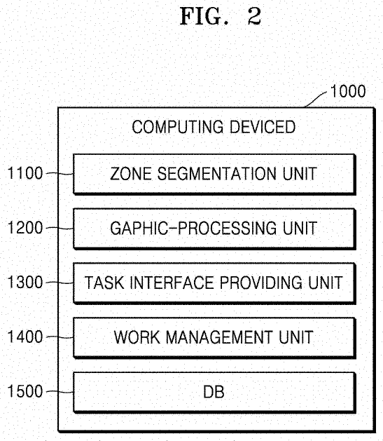

FIG. 2 schematically shows internal components of the computing device 1000 performing a method for dividing and providing a work to workers in crowdsourcing according to one embodiment of the present invention.

As shown in FIG. 2, the computing device 1000 performing the method for dividing and providing a work to workers in crowdsourcing according to the present invention includes a zone segmentation unit 1100, a graphic-processing unit 1200, a task interface providing unit 1300, a work management unit 1400, and a DB 1500.

The zone segmentation unit 1100 segments the work into the predetermined number of zones. Specifically, the zone segmentation unit 1100 segments the work into a predetermined number of zones, rather than completely dividing the work into the predetermined number of zones, so that an object spanning a border of an adjacent zone is prevented from being split. According to the above configuration, the worker assigned to a task on the specific zone of the work may perform a task on an object spanning the specific zone and the zone adjacent to the specific zone.

Meanwhile, number information on a plurality of zones for segmenting a work may be set by an administrator of the computing device 1000 or a user of the data requestor terminal providing the work. In addition, the number information may have a differential value according to a size of the work or the number of objects contained in the work. For example, when the work has a size less than a first size, the number information for the work may have a first value; when the work has a size larger than or equal to the first size and smaller than a second size, the number information for the work may have a second value; and when the work has a size larger than or equal to a third size, the number information for the work may have a third value.

According to the above configuration, the zone segmentation unit 1100 may determine the number of a plurality of zones for segmenting a corresponding work, based on the size of the work or the number of objects contained in the work.

the graphic-processing unit 1200 graphically processes a specific zone to be assigned to a worker in the work segmented into a plurality of zones by the zone segmentation unit 1100 so as to be displayed differently from other zones. As described above, the zone segmentation unit 1100 discretely segments the work into a plurality of zones, rather than completely dividing the work into a plurality of zones, so that the graphic-processing is performed by the graphic-processing unit 1200 on a specific zone to be assigned to a worker.

In the graphic-processing unit 1200, only the specific zone provided to the worker may be graphic-processed so that the specific zone is displayed visually differently from the entire remaining zones other than the specific zone, or the segmented zones may be graphic-processed, respectively so that the zones are displayed visually differently from each other.

In the task interface providing step S12, the work, which is graphic-processed by the graphic-processing unit 1200, on the specific zone is transmitted to the worker terminal 2000 of the worker assigned to the work on the specific area. Specifically, in the task interface providing step S12, a task interface is provided to the worker terminal 2000, and the task interface includes the graphic-processed work. Accordingly, through the task interface displayed on the worker terminal 2000 the worker may perform unit tasks for the specific zone displayed differently in the work segmented into a plurality of zones. More specifically, the worker may perform a unit task of selecting a work target area for an object corresponding to the unit task for the work among one or more objects included in the specific zone.

The work management unit 1400 may determine workers to be assigned to segmented zones, respectively, in a work segmented into a predetermined number of zones, and integrate task results performed by the workers for the assigned zones, thereby outputting a task result for the entire work.

According to another embodiment of the present invention, when integrating the task results performed by the workers for the assigned zones, the work management unit 1400 may integrate task results having passed reviews for the task results based on reviews of the reviewers.

Information inputted for each component of the above-described computing device 1000 or derived from each component may be stored in the DB 1500. For example, a work segmented in the zone segmentation unit 1100, a work segmented into a predetermined number of zones by the zone segmentation unit 1100, index information on each of the predetermined number of zones, a task result on a specific zone of a work performed by each worker, and a work result on the entire work outputted from the work management unit 1400 may be stored.

According to another embodiment of the present invention, the computing device 1000 may not include the DB 1500, and the information stored in the above-described DB 1500 may be simply stored in at one memory included in the computing device 1000.

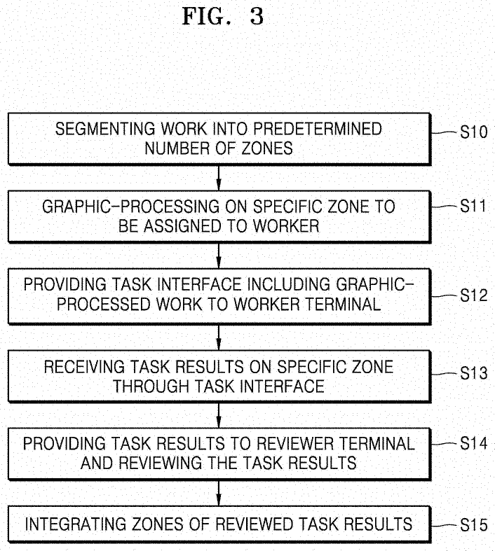

FIG. 3 schematically shows the overall steps of the method for dividing and providing a work to workers in crowdsourcing according to one embodiment of the present invention.

As shown in FIG. 3, a method for dividing and providing a work to workers in crowdsourcing performed on a computing device 1000 including at least one processor and at least one memory includes: a zone segmentation step (S10) of segmenting a work including at least one unit task into a predetermined number of zones; a graphic-processing step (S11) of graphic-processing a specific zone to be assigned to a worker in the work segmented into the predetermined number of zones so as to be displayed differently from other zones; and a task interface providing step (S12) of providing a task interface including the work formed by graphic-processing the specific zone to a worker terminal 2000 of the worker, wherein the worker may select a task target area for an object through the worker terminal 2000 displaying the task interface, and the selecting of the task target area may include: selecting an area in which the object is completely included in the specific zone; and selecting an area in which a part of the object is included in the specific zone and a remainder of the object deviates from the specific zone in at least one direction according to a preset boundary rule from the specific area.

Specifically, in the zone segmentation step (S10) performed by the zone segmentation unit 1100, the work pre-stored in the computing device 1000 or received from the above-described data requestor terminal is segmented into a predetermined number of zones.

More specifically, information on the number of the zones segmented for the work in the zone segmentation step (S10) may be set by the administrator of the computing device 1000 or the user of the data requestor terminal. According to another embodiment of the present invention, the information on the number may be differentially set according to a size of the work or a magnitude of the objects contained in the work.

In the graphic-processing step S11 performed by the graphic-processing unit 1200, the specific zone to be assigned to the worker is graphic-processed so as to be displayed differently from other zones in the work segmented into a predetermined number of zones in the zone segmentation step S10. In the graphic-processing step, various techniques of graphic-processing may be performed for the corresponding specific zone.

For example, the graphic-processing may be performed, such as masking the specific zone with a color of a predetermined transparency, highlighting a boundary of that specific zone, or darkening the remaining zones except for the specific zone.

Meanwhile, in the graphic-processing step S11, information on determining a zone to be assigned to a specific worker in the work divided into a plurality of zones may be determined by the work management unit 1400. Accordingly, in the graphic-processing step S11, worker assignment information for each zone may be received from the work management unit 1400, so that graphic-processing for the specific zone to be assigned to the specific worker may be performed.

In the task interface providing step S12 performed by task interface providing unit 1300, the work including the graphic-processed specific zone in the graphic-processing step S11 may be provided to the worker terminal 2000 of the corresponding worker. More specifically, in the task interface providing step S12, the task interface may be provided to the worker terminal 2000 of the corresponding worker, and the work after graphic-processing the specific zone may be displayed on the task interface.

The worker terminal 2000 may display the task interface received in the task interface providing step S12, and the worker may perform a unit task of selecting an area of at least one object included in the specific zone, that is, a task target area in the specific zone graphically processed on the task interface.

Meanwhile, in addition to the work containing the graphic-processed specific zone, the task interface may display, for example, task instruction information for one or more unit tasks corresponding to the work, an element for granting a predetermined value to the task target area selected by the worker, and an element for transmitting a task result for the unit task performed by the worker to the computing device 1000.

More specifically, the task, by the worker, of selecting the task target area for the object contained in the specific zone on the task interface may refer to a task performed by including the object into a predetermined shape (bounding box), or giving three or more points to a periphery of the object to automatically connect adjacent points (polygon).

In addition, in order to select a task target area for the object contained in the specific zone on the task interface, the worker may select the task target area even when a part of the object is contained in the specific zone and a remainder of the object deviates from the specific zone.

Preferably, the worker may not be allowed to always select the task target area when a part of the object is contained in the specific zone and a remainder of the object deviates from the specific zone, and may select the task target area only when the remainder of the object deviates in one or more directions based on a preset boundary rule.

Accordingly, the worker can select a task target area for an object having a part included in the specific zone in which the task is required to be performed on the task interface, and a remainder deviating from the specific zone. Accordingly, when the work is segmented into a plurality of zones, the task may be performed without omission even on an object spanning a boundary between the zones, and a plurality of workers working on adjacent zones may be prevented from repeatedly working the object spanning the boundary, through the above-mentioned boundary rule.

Accordingly, the worker, through the task interface displayed on the worker terminal 2000, performs one or more unit tasks in the graphic-processed specific zone for the work to generate task results, and the worker terminal 2000 transmits the task results to the computing device 1000 according to the worker's selection input, and receives the task results from the work management unit 1400 included in the computing device 1000 (S13).

Meanwhile, the work management unit 1400 provides a plurality of task results received from each worker having performed the tasks for a predetermined number of zones of the work to a plurality of reviewer terminals 3000, each reviewer performs reviews on the provided task results, and the work management unit 1400 receives review results for the task results from the reviewer terminal 3000 (S14).

The work management unit 1400 may provide one task result to a plurality of reviewers to receive a plurality of review results corresponding to the one task result, and determine whether the task result passes or not based on the review results on each task result for each zone. When the task result is determined as failing to pass, the worker having performed the task result may perform the task again. Likewise, the task result of the worker may be provided to a plurality of reviewers and a plurality of review results may be received, so as to determine whether the task result performed again passes.

Then, the work management unit 1400 integrates the task results for each zone of the work passing the review, so that a task result for the entire work is outputted (S15).

Thus, according to the present invention, one work is segmented into a plurality of zones, a plurality of workers perform tasks for each zone, and task results performed by the workers are combined, so that a large-scale work can be effectively processed.

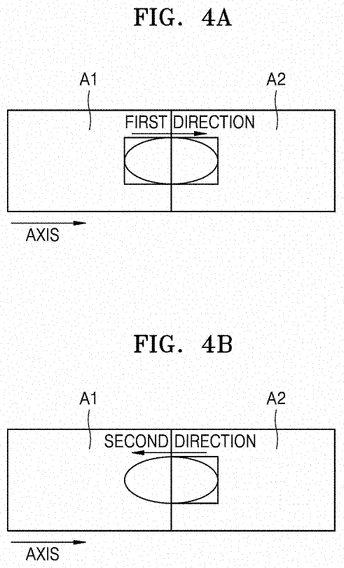

FIGS. 4A and 4B schematically show a boundary rule for work segmented into one-dimensional zones according to one embodiment of the present invention.

In the present invention, the worker assigned to a specific zone may select a task target area even for an object spanning a boundary of a specific zone and other zones adjacent to the specific zone based on the boundary rule on the task interface.

FIGS. 4A and 4B schematically show a boundary rule when the work is segmented into a plurality of zones along one axis. Specifically, in FIGS. 4A and 4B, the work is segmented into two zones A1 and A2 along the horizontal axis.

In the above case, as shown in FIG. 4A, when a part of an object (the object indicated by an oval in FIGS. 4A and 4B) is included in specific zone A1 and a remainder of the object deviates from specific zone A1 in the first direction along the horizontal axis, the boundary rule may allow the worker working on specific zone A1 to select a task target area for the object.

On the contrary, as shown in FIG. 4B, regarding zone A2, since a part of the object is included in in zone A2 but the remainder of the object deviates from zone A2 in the second direction along the horizontal axis, when the worker working for zone A2 selects a task target area for the object, the worker has no choice but to select only the part of the object included in zone A2 based on the boundary rule. As a result, the worker fails to select the entire object as the task target area.

FIGS. 4A and 4B show that the task target area can be selected for the object deviating in the first direction. However, the present invention is not limited thereto. On the contrary, in another embodiment of the present invention, the task target area can be selected for the object deviating in the second direction, and the task target area cannot be selected for the object deviating in the first direction.

In addition, although not shown in FIGS. 4A and 4B, even when the work is segmented into a plurality of zones along the vertical axis, a task target area for an object spanning a boundary of the zones can be selected based on a boundary rule.

For example, when a part of the object is included in a specific zone and a remainder of the object deviates in the first direction of the vertical axis, the worker in the specific zone, based on the boundary rule can select the task target area for the object, and when the remainder deviates in the second direction, the worker in the specific zone, based on the boundary rule fails to select the entire object as the task target area.

Meanwhile, the boundary rule is illustrated in FIGS. 4A and 4B based on specific zone A1, however, the above boundary rule may be equally applied to the remaining zone A2 for the work.

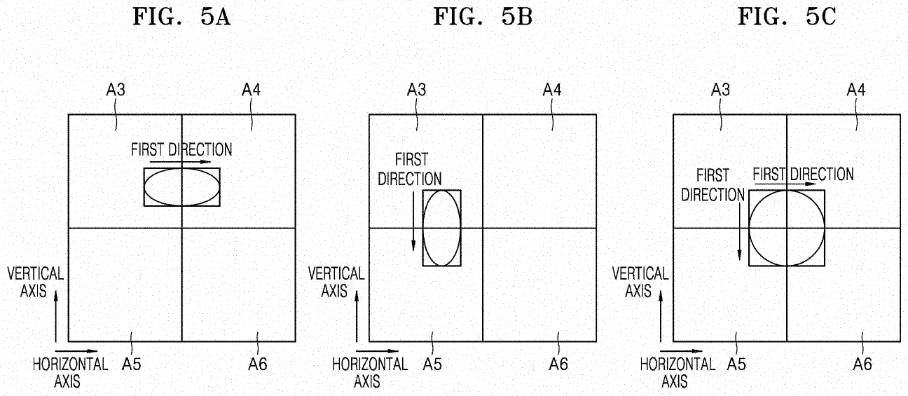

FIGS. 5A, 5B, and 5C schematically show a boundary rule for a work segmented into two-dimensional zones according to one embodiment of the present invention.

The drawings shown in FIGS. 5A, 5B, and 5C expanding from the above-described FIGS. 4A and 4B schematically show a boundary rule when a work is segmented into two-dimensional zones. Specifically, in FIGS. 5A, 5B, and 5C, the work is segmented into four zones A3, A4, A5 and A6 along the horizontal and vertical axes.

In the above case, as shown in FIG. 5A, when a part of an object (the object indicated by an oval in FIG. 5A is included in specific zone A3 and a remainder of the object deviates from specific zone A3 only in the first direction along the horizontal axis, the boundary rule may allow the worker working on specific zone A3 to select a task target area for the object on the task interface.

On the contrary, based on the boundary rule, since a part of the object is included in in zone A4, however, the remainder of the object deviates in the second direction along the horizontal axis, the object cannot be selected as the task target area, and since zones A5 and A6 do not contain the object itself, the object cannot be selected as the task target area.

In addition, as shown in FIG. 5B, when a part of an object (the object indicated by an oval in FIG. 5B is included in specific zone A3 and a remainder of the object deviates from specific zone A3 only in the first direction along the vertical axis, the boundary rule may allow the worker working on specific zone A3 to select a task target area for the object on the task interface.

On the contrary, based on the boundary rule, since a part of the object is included in in zone A5, however, the remainder of the object deviates in the second direction along the vertical axis, the object cannot be selected as the task target area, and since zones A4 and A6 do not contain the object itself, the object cannot be selected as the task target area.

Likewise, as shown in FIG. 5C, when a part of an object (the object indicated by a circle in FIG. 5C is included in specific zone A3 and a remainder of the object deviates from specific zone A3 in the first direction along the horizontal axis and deviates in the first direction along the vertical axis, the boundary rule may allow the worker working on specific zone A3 to select a task target area for the object on the task interface.

On the contrary, based on the boundary rule, a part of the object is included in in zone A4 and a remainder of the object deviates in the first direction of the vertical axis, however, the remainder of the object deviates in the second direction along the horizontal axis, and accordingly, the object cannot be selected as the task target area in zone A4.

In addition, a part of the object is included in in zone A5 and a remainder of the object deviates in the first direction along the horizontal axis, however, the remainder of the object deviates in the second direction along the vertical axis, and accordingly, the object cannot be selected as the task target area in zone A5, either, based on the boundary rule.

Finally, a part of the object is included in in zone A6, however, a remainder of the object deviates in the second directions along the vertical and horizontal axes, and accordingly, the object cannot be selected as the task target area in zone A6, either.

The boundary rule is illustrated based on specific zone A3 in FIGS. 5A, 5B, and 5C, however, the above boundary rule may be equally applied to each of the remaining zones A4, A5 and A6 of the work.

Accordingly, in the present invention, the work may be segmented into a plurality of zones in one or two dimensions, and a specific zone for selecting an object spanning the zones as a task target may be assigned based on the boundary rules, so that a task may be performed without omission even on objects that span a plurality of zones.

Hereinafter, boundary rules applied according to types of the work will be described in detail.

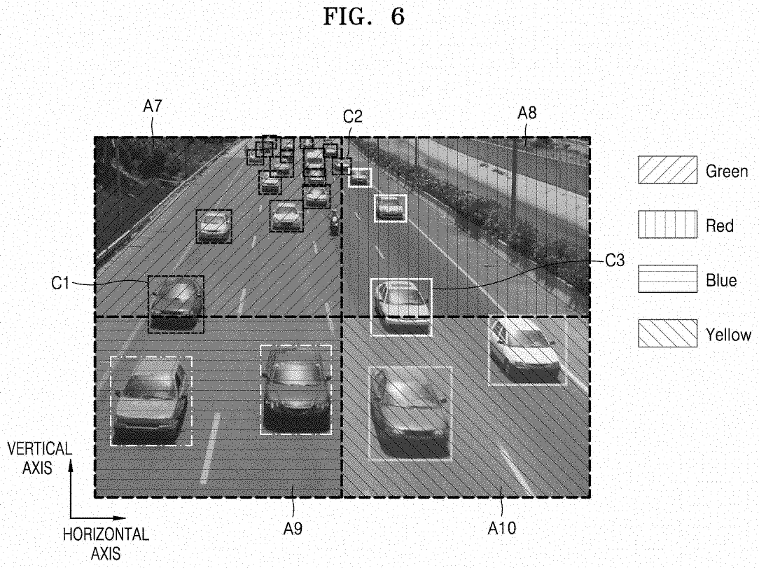

FIG. 6 schematically shows image data segmented into a plurality of zones in which tasks are performed for each zone according to one embodiment of the present invention.

As shown in FIG. 6, the work may include image data including at least one image object, and the boundary rule may include: selecting an area in which a part of the object is included in the specific zone and a remainder of the image object deviates from the specific zone in a first direction of a horizontal axis of the image data; selecting an area in which a part of the object is included in the specific zone and a remainder of the image object deviates from the specific zone in a first direction of a vertical axis of the image data; and selecting an area in which a part of the object is included in the specific zone and a remainder of the image object deviates from the specific zone in the first direction of the horizontal axis and the first direction of the vertical axis of the image data.

Specifically, as shown in FIG. 6, the work may be image data, and the image data may include one or more image objects. For example, the image data shown in FIG. 6 includes image objects such as vehicles, motorcycles, lanes, and street trees.

In the zone segmentation step S10, the image data as the work is segmented into a predetermined number of zones, and the image data is segmented into four zones A7, A8, A9, and A10 along the horizontal and vertical axes in FIG. 6.

According to another embodiment of the present invention, in the zone segmentation step S10, when the image data extends, like a panoramic image, only in the horizontal or vertical axis, the image data may be segmented into a predetermined number of zones in one dimension along the horizontal or vertical axis.

In the graphic-processing step S11, graphic-processing may be performed so that the specific zone assigned to the worker is displayed differently from other zones. In FIG. 6, each zone is masked with a color having a predetermined transparency.

According to another embodiment of the present invention, in the graphic-processing step S11, the graphic-processing may be performed only on a specific zone assigned to the worker. In addition to masking with the color having the predetermined transparency, the graphic-processing may be performed in various ways such as highlighting a boundary of the zone or adjusting the brightness of the specific zone or remaining zones.

In the task interface providing step S12, the task interface including image data graphic-processed on the specific zone is provided to the worker terminal 2000 of the corresponding worker. The corresponding worker may select the task target area for the image object included in the specific zone assigned through the task interface displayed on the worker terminal 2000, so as to perform unit tasks for the corresponding image data.

Meanwhile, when the image object is included in the specific area, but a part of the image object deviate from the specific zone, the worker in the specific zone may select the task target area for the image object based on the boundary rule.

Taking the image data shown in FIG. 6 as an example, when the unit task for the image data is labeling the vehicles, the worker in zone A7 may perform the unit task by firstly selecting vehicle objects completely included in zone A7 as the task target area. FIG. 6 shows that the task target area is selected using a bounding box type of setting an object area as a predetermined shape. Meanwhile, two vehicle objects in zone A7 are not completely included in zone A7, and the zone in which the vehicle objects can be selected as the task target area among zones A7, A8, A9, and A10 may be determined according to the boundary rule for image data.

Specifically, for a vehicle object having a part is included at the bottom of zone A7 and a remainder included at the top of zone A9, zone A7 includes the part of the vehicle object and the remainder of the vehicle object deviates in the first direction of the vertical axis, and accordingly, the vehicle object may be selected as a task target area C1 by the worker in zone A7 according to the boundary rule. Whereas, in zone A9, because the remainder of the vehicle object deviates in the second direction of the vertical axis, the worker of zone A9 cannot select the entire vehicle object as the task target area C1 according to the boundary rule.

In addition, for a vehicle object having a part included at a right end of zone A7 and a remainder at a left end of zone A8, because zone A7 includes the part of the vehicle object and the remainder of the vehicle object deviates in the first direction of the horizontal axis, the vehicle object may be selected as a task target area C2 by the worker of zone A7 according to the boundary rule. Whereas, in zone A8, because the remainder of the vehicle object deviates in the second direction of the horizontal axis, the worker of zone A8 cannot select the entire vehicle object as the task target area C2 according to the boundary rule.

Likewise, for the vehicle object spanning the bottom of zone A8 and the top of zone A10, the vehicle object may be selected as a task target area C3 by the worker of the selection A8 according to the boundary rule.

Accordingly, when the work is image data, a zone for selecting the zone having an image object spanning a boundary of the zone may be determined based on a boundary rule for the first directions of the horizontal and vertical axes in the image data.

Meanwhile, in FIG. 6, based on the boundary rule for image data, the first direction of the horizontal axis is illustrated as the right direction and the first direction of the vertical axis is illustrated as the downward direction. However, the present invention is not limited thereto, and in another embodiment of the present invention, the first direction of the horizontal axis may be the left direction and the first direction of the vertical axis may be upward direction.

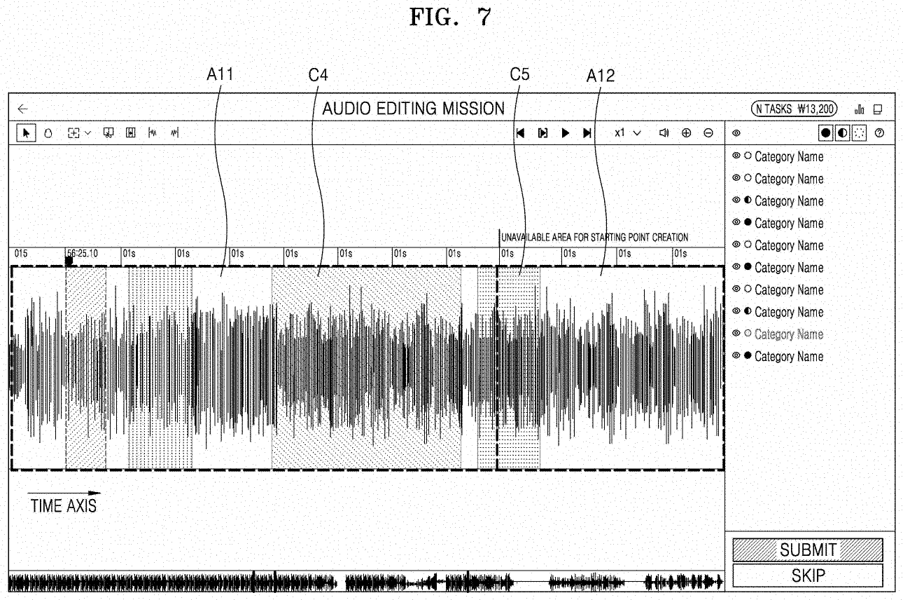

FIG. 7 schematically shows audio data segmented into a plurality of zones in which tasks are performed for each zone according to one embodiment of the present invention.

As shown in FIG. 7, the work may include audio data including at least one audio object, and the zone segmentation step S10 may include segmenting the audio data into a predetermined number of zones according to a preset time interval, and the graphic-processing step S11 may include graphic-processing a specific area to be assigned to a worker so as to be displayed differently from other zones in a waveform of the audio data visually displayed on an axis of time.

Specifically, as shown in FIG. 7, the work may be audio data, and the audio data may include one or more audio objects. For example, the audio data may include audio objects such as a male voice, a female voice, and an animal cry, or each of predetermined sections in a voice of one person may correspond to the audio object.

In the zone segmentation step S10, audio data as a work may be segmented into a predetermined number of zones according to predetermined time intervals, and the time interval may be set by the administrator of the computing device 1000 or the user of the data requestor terminal. In FIG. 7, the audio data is segmented into two zones A11 and A12.

in the graphic-processing step S11, an audio waveform of the audio data is visually displayed, in which an audio waveform corresponding to the specific zone is graphic-processed so that the specific zone assigned to a worker is displayed differently from other zones in the audio waveform. In FIG. 7, a remaining zone A12 other than the specific zone is darkly graphic-processed.

Accordingly, in the case of using the audio data as a work, in the graphic-processing step S11, the audio waveform of audio data with time as an axis is visually displayed, and the audio waveform corresponding to the specific zone to be assigned to the worker is graphic-processed so as to be displayed differently from audio waveforms corresponding to other zones, so that the worker may easily identify the section of the audio data required to be handled by the worker.

In the task interface providing step S12, the task interface including audio data graphic-processed on the specific zone is provided to the worker terminal 2000 of the corresponding worker. The corresponding worker may select the task target area for the audio object included in the specific zone assigned through the task interface displayed on the worker terminal 2000, so as to perform unit tasks for the corresponding audio data.

Meanwhile, according to the boundary rule when the work is audio data, an area, in which a part of the object is included in the specific zone and a remainder of the audio object deviates from the specific zone in a first direction of the time axis of the audio data, may be selected.

Specifically, taking the audio data shown in FIG. 7 as an example, when the unit task for the audio data is labeling a specific audio object, the worker performing tasks on zone A11, first, may select an audio object completely included in zone A11 as the task target area C4 to perform the unit tasks. Meanwhile, in zone A11, the specific audio object is are not completely included in zone A11, and the zone in which the audio object can be selected as the task target area between zones A11 and A12 may be determined according to the boundary rule for audio data.

More specifically, for the audio object having a part included at the right of zone A11 and a remainder included at the left of zone A12, because zone A11 includes the part of the audio object and the remainder of the audio object deviates in the first direction of the time axis, the audio object may be selected as a task target area C5 by the worker of zone A11 based on the boundary rule. Whereas, in zone A12, because the remainder of the audio object deviates in the second direction of the time axis, the worker of area A12 cannot select the entire audio object as the task target area C5 based on the boundary rule.

Accordingly, when the work is audio data, a zone for selecting the zone having an audio object spanning a boundary of the zone may be determined based on the boundary rule for the first direction along the time axis of the audio data.

Meanwhile, in FIG. 7, the first direction of the time axis is illustrated as the forward direction of time in the boundary rule for audio data. However, the present invention is not limited thereto, and in another embodiment of the present invention, the first direction of the time axis may be the reverse direction of time.

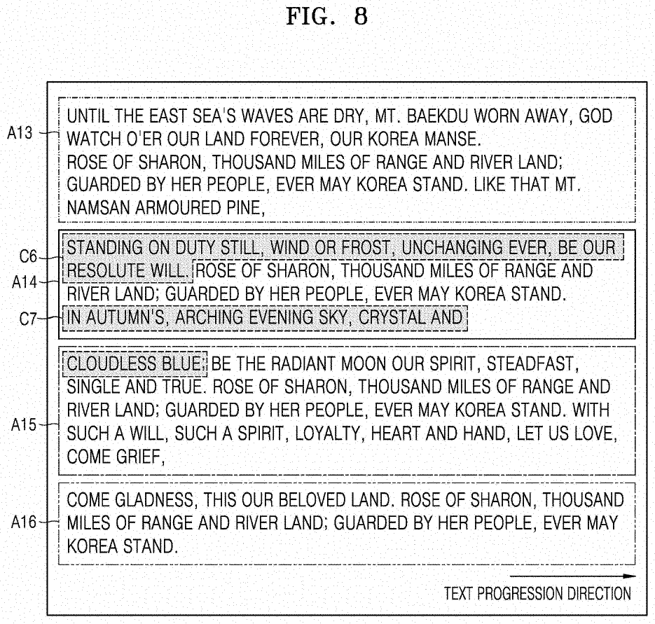

FIG. 8 schematically shows text data segmented into a plurality of zones in which tasks are performed for each zone according to one embodiment of the present invention.

As shown in FIG. 8, the work may include text data including a plurality of unit texts, and an area of the unit texts having a part included in the specific zone and a remainder deviating from the specific zone in a text progression direction of the text data may be selected based on the boundary rule.

Specifically, as shown in FIG. 8, the work may be text data, and the text data may include a plurality of unit texts. The unit text may be any one of sub-elements of text, such as a syllable, a sentence, or a paragraph.

In the zone segmentation step S10, the text data as the work is segmented into a predetermined number of zones, and in FIG. 8, the text data is segmented into a predetermined number of zones according to the text progression direction. In FIG. 8, the text data is segmented into four zones A13, A14, A15, and A16 having predetermined text lines according to the text progression direction.

According to another embodiment of the present invention, in the zone segmentation step S10, the zone may be segmented based on a preset number of syllables, sentences, paragraphs or the like according to the text progression direction.

In the graphic-processing step S11, graphic-processing may be performed so that the specific zone assigned to the worker is displayed differently from other zones. In FIG. 8, each zone is masked with a color having a predetermined transparency. As described above, in the graphic-processing step S11, the graphic-processing may be performed only on a specific zone assigned to the worker. In addition to masking with the color having the predetermined transparency, the graphic-processing may be performed in various ways such as highlighting a boundary of the zone or adjusting the brightness of the specific zone or remaining zones.

In the task interface providing step S12, the task interface including text data graphic-processed on the specific zone is provided to the worker terminal 2000 of the corresponding worker. The corresponding worker may select the task target area for one or more unit texts included in the specific zone assigned through the task interface displayed on the worker terminal 2000, so as to perform unit tasks for the corresponding text data.

Meanwhile, when one or more unit texts to be selected as a task target area are included in a specific zone, but a part of the one or more unit texts deviates from the specified zone, the worker in the specific zone may select a task target area for the one or more unit texts based on the boundary rule.

Taking the text data shown in FIG. 8 as an example, when the unit task for the text data is labeling a specific phrase including one or more unit texts, the worker of zone A14, first, may select one or more unit texts completely included in zone A14 as a task target area C6 to perform the unit tasks. FIG. 8 shows that the task target area is selected by drag-inputting one or more unit texts corresponding to the task target area. Meanwhile, the one or more other unit texts required to be selected as the task target area in section A14 are not completely included in zone A14. The zone in which one or more unit texts can be selected as the task target area may be determined according to boundary rule for text data.

Specifically, for one or more unit texts having a part included in a last portion in the text progression direction of section A14 and a remainder included in a first portion in the text progression of zone A15, since zone A14 includes the part of the one or more unit texts and the remainder of the one or more unit texts deviate in the first direction of the text progression direction, the one or more unit texts may be selected as a task target area C7 by the worker of zone A14 based on the boundary rule. Whereas, since zone A15 includes the part of the one or more unit texts, but the remainder of the one or more unit texts deviate in the second direction of the text progression direction, the worker of zone A15 cannot select all of the one or more unit texts as the task target area C7 based on the boundary rule.

Accordingly, when the work is text data, a zone for selecting the zone having one or more unit texts spanning a boundary of the zone may be determined based on the boundary rule for the first direction of the text progression direction in the text data.

Meanwhile, in FIG. 8, the first direction of the text progression direction is illustrated as the forward direction of the text progression direction based on the boundary rule for text data. However, the present invention is not limited thereto, and in another embodiment of the present invention, the first direction of the text progression direction may be a reverse direction of the text progression direction.

Further, in the above boundary rule for text data, the text progression direction refers to a direction used in majority of languages in which text progresses from left to right, however, may refer to a ‘Z’-shaped progression direction in which a line of text changes and the text progresses from left to right again in the next line other than simply progressing from left to right.

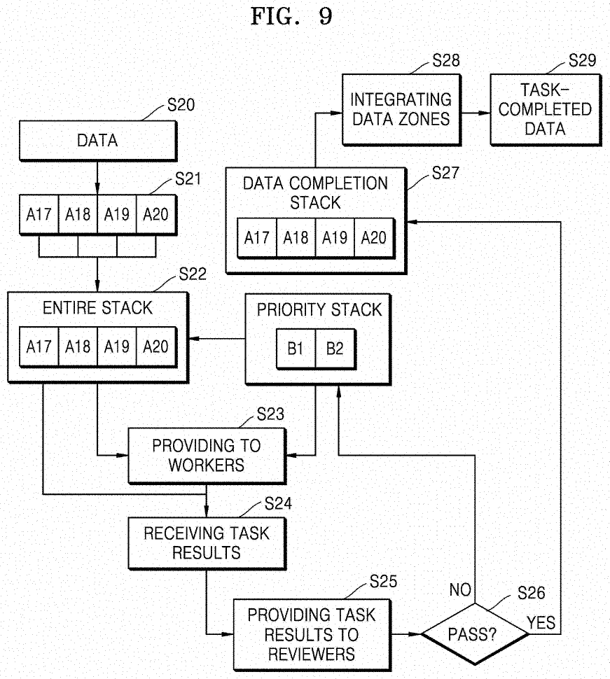

FIG. 9 schematically shows a process of processing data segmented into a plurality of zones according to one embodiment of the present invention.

As shown in FIG. 9, in the zone segmentation step S10, the data as the work is segmented into a predetermined number of zones (S20). In FIG. 9, the data is segmented into a total of four zones A17, A18, A19, and A20. As described above, the data may include any one of image data, audio data, or text data.

Meanwhile, in the graphic-processing step S11, the segmented zones are graphic-processed so as to be displayed visually differently from each other (S21). The data, which has the zones graphic-processed visually differently through the graphic-processing step S11, is moved to an entire stack (S22). Meanwhile, a series of operations for managing the entire stack may be performed by the work management unit 1400.

Thereafter, in the task interface providing step S12, the data moved to the entire stack is provided to the worker terminal 2000 of the worker (S23). Specifically, in the task interface providing step S12, the data having the graphic-processed specific zone performed by the worker is provided to the worker terminal 2000. More specifically, the task interface is provided to the worker terminal 2000, and the task interface may include the data having the graphic-processed specific zone to be performed by the worker.

According to another embodiment of the present invention, in order to provide the data having the graphic-processed specific zone to the worker terminal 2000, a task request inputted by the worker through the worker terminal 2000 is received, so that the data moved to the entire stack is transmitted to the worker terminal 2000 transmitting the task request. When a plurality of worker terminals 2000 transmit task requests, the worker terminals 2000 may be sequentially provided with data beginning from the first data moved to the entire stack according to a sequence transmitting the task requests.

In another embodiment of the present invention, the computing device 1000 may include a priority stack. When data is included in the priority stack, the data included in the priority stack may be provided firstly to the worker terminal 2000 transmitting the task request. Meanwhile, when the data moved to the priority stack is not provided to the worker terminal 2000 during preset remaining time, the data can be moved to the entire stack.

The worker may output a task result by performing unit tasks for a specific zone through the task interface displayed on the worker terminal 2000. The work management unit 1400 may receive the task result outputted from the worker terminal 2000 (S24).

Meanwhile, when the worker does not perform a task, during preset waiting time, on the data having graphic-processed specific zone included in the work interface displayed on the worker terminal 2000, the data having the graphic-processed specific area assigned to the worker may be moved back to the entire stack.

Next, the work management unit 1400 provides the received task result to reviewer terminals 3000 of a plurality of reviewers (S25), each of the reviewers reviews the task results and outputs a review result, and the work management unit 1400 receives the review results from the reviewer terminals 3000.

In addition, the work management unit 1400 determines whether the task result has been correctly performed based on the task result and the review results for the task result (S26). When it is determined that the task result fails to pass, the work management unit 1400 moves the data corresponding to the task result to the priority stack, and when it is determined that the task result passes, the work management unit 1400 moves the data to which the corresponding task result is applied to a data completion stack (S27).

In step S26, the pass of the task result may be determined in various ways. For example, according to one embodiment of the present invention, when more than half of the review results on the task result determine the task result as passing the review, the work management unit 1400 may determine that the task result has passed. In addition, in another embodiment of the present invention, weights are given to the review results, respectively, while considering the review results on the task result and the reliability of each reviewer, so as to determine whether the task result passes or not. In addition, the reliability of each reviewer may be preset or may be updated, from a preset initial value, based on the review results performed with respect to a plurality of task results of each of the reviewers.

According to another embodiment of the present invention, the data corresponding to the task result failing to pass and moved to the priority stack may be provided again to the worker terminal 2000 that has submitted the work result. When the data is provided again to the worker terminal 2000, data before the task result is applied thereto may be provided to the worker terminal 2000. Preferably, the data, to which the task result performed by the worker is applied, may be provided again, so that the corresponding worker may output a task result again only by partially correcting the task result performed by the worker.

Meanwhile, when all of data, to which the task results for each of a predetermined number of zones segmenting the data are applied, are moved to the data completion stack, the work management unit 1400 integrates the task results passed for each of the predetermined number of zones into one data (S28).

For example in FIG. 6, in step S28, task results performed by the worker for zone A7, task results performed by the worker for zone A8, task results performed by the worker for zone A9, and task results performed by the worker for zone A10 are integrated, so that a plurality of task results are applied to entire data as shown in FIG. 6.

Meanwhile, for an object spanning a boundary of each zone, since a task target area can be selected only by a worker working on a specific zone based on a boundary rule, so that the object spanning the boundary can be prevented from being redundantly handled upon integrating the task results in step S28.

Finally, in step S29, the entire data formed by labeling one or more objects according to unit tasks may be outputted through processes such as removing graphic-processed elements from the integrated data.

Accordingly, in the computing device 1000 of the present invention segments the work into a predetermined number of zones, graphically processes each zone and provides the graphically processed zones to a plurality of workers, respectively, and finally, integrates task results performed by a plurality of workers for the entire work through the process of reviewing the task results performed by the workers for the zones, so that the tasks can be rapidly completed compared to the related art in which one worker performs the tasks on one work, and task quality of a large-scale work can be prevented from being deteriorated since the concentration level of the worker for the large-scale work gradually decreases as working time increases.

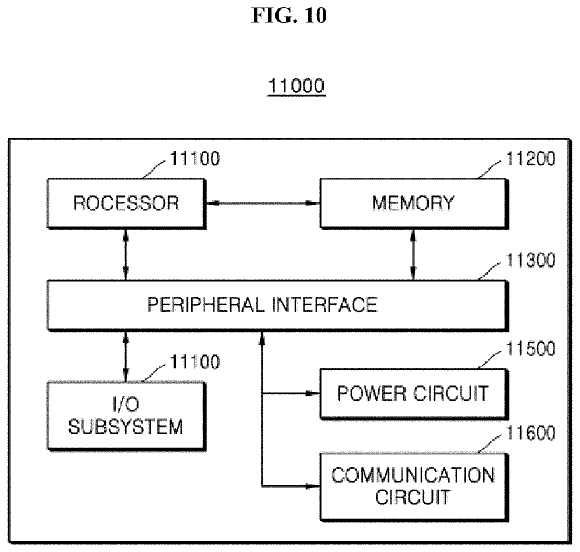

FIG. 10 schematically shows internal components of the computing device according to one embodiment of the present invention.

The computing device 1000 shown in the above-described FIG. 1 may include components of the computing device 11000 shown in FIG. 10.

As shown in FIG. 10, the computing device 11000 may at least include at least one processor 11100, a memory 11200, a peripheral device interface 11300, an input/output subsystem (I/O subsystem) 11400, a power circuit 11500, and a communication circuit 11600. The computing device 11000 may correspond to the computing device 1000 shown in FIG. 1.

The memory 11200 may include, for example, a high-speed random access memory, a magnetic disk, an SRAM, a DRAM, a ROM, a flash memory, or a non-volatile memory. The memory 11200 may include a software module, an instruction set, or other various data necessary for the operation of the computing device 11000.

The access to the memory 11200 from other components of the processor 11100 or the peripheral interface 11300, may be controlled by the processor 11100.

The peripheral interface 11300 may combine an input and/or output peripheral device of the computing device 11000 to the processor 11100 and the memory 11200. The processor 11100 may execute the software module or the instruction set stored in memory 11200, thereby performing various functions for the computing device 11000 and processing data.

The input/output subsystem may combine various input/output peripheral devices to the peripheral interface 11300. For example, the input/output subsystem may include a controller for combining the peripheral device such as monitor, keyboard, mouse, printer, or a touch screen or sensor, if needed, to the peripheral interface 11300. According to another aspect, the input/output peripheral devices may be combined to the peripheral interface 11300 without passing through the I/O subsystem.

The power circuit 11500 may provide power to all or a portion of the components of the terminal. For example, the power circuit 11500 may include a power failure detection circuit, a power converter or inverter, a power status indicator, a power failure detection circuit, a power converter or inverter, a power status indicator, or any other components for generating, managing, and distributing the power.

The communication circuit 11600 may use at least one external port, thereby enabling communication with other computing devices.

Alternatively, as described above, if necessary, the communication circuit 11600 may transmit and receive an RF signal, also known as an electromagnetic signal, including RF circuitry, thereby enabling communication with other computing devices.

The above embodiment of FIG. 10 is merely an example of the computing device 11000, and the computing device 11000 may have a configuration or arrangement in which some components shown in FIG. 10 are omitted, additional components not shown in FIG. 10 are further provided, or at least two components are combined. For example, a computing device for a communication terminal in a mobile environment may further include a touch screen, a sensor or the like in addition to the components shown in FIG. 10, and the communication circuit 11600 may include a circuit for RF communication of various communication schemes (such as WiFi, 3G, LTE, Bluetooth, NFC, and Zigbee). The components that may be included in the computing device 11000 may be implemented by hardware, software, or a combination of both hardware and software which include at least one integrated circuit specialized in a signal processing or an application.

The methods according to the embodiments of the present invention may be implemented in the form of program instructions to be executed through various computing devices, thereby being recorded in a computer-readable medium. In particular, a program according to an embodiment of the present invention may be configured as a PC-based program or an application dedicated to a mobile terminal. The application to which the present invention is applied may be installed in the computing device 11000 through a file provided by a file distribution system. For example, a file distribution system may include a file transmission unit (not shown) that transmits the file according to the request of the computing device 11000.

The above-mentioned device may be implemented by hardware components, software components, and/or a combination of hardware components and software components. For example, the devices and components described in the embodiments may be implemented by using at least one general purpose computer or special purpose computer, such as a processor, a controller, an arithmetic logic unit (ALU), a digital signal processor, a microcomputer, a field programmable gate array (FPGA), a programmable logic unit (PLU), a microprocessor, or any other device capable of executing and responding to instructions. The processing device may execute an operating system (OS) and at least one software application executed on the operating system. In addition, the processing device may access, store, manipulate, process, and create data in response to the execution of the software. For the further understanding, some cases may have described that one processing device is used, however, it is well known by those skilled in the art that the processing device may include a plurality of processing elements and/or a plurality of types of processing elements. For example, the processing device may include a plurality of processors or one processor and one controller. In addition, other processing configurations, such as a parallel processor, are also possible.

The software may include a computer program, a code, and an instruction, or a combination of at least one thereof, and may configure the processing device to operate as desired, or may instruct the processing device independently or collectively. In order to be interpreted by the processor or to provide instructions or data to the processor, the software and/or data may be permanently or temporarily embodied in any type of machine, component, physical device, virtual equipment, computer storage medium or device, or in a signal wave to be transmitted. The software may be distributed over computing devices connected to networks, so as to be stored or executed in a distributed manner. The software and data may be stored in at least one computer-readable recording medium.

The method according to the embodiment may be implemented in the form of program instructions to be executed through various computing mechanisms, thereby being recorded in a computer-readable medium. The computer-readable medium may include program instructions, data files, data structures, and the like, independently or in combination thereof. The program instructions recorded on the medium may be specially designed and configured for the embodiment, or may be known to those skilled in the art of computer software so as to be used. An example of the computer-readable medium includes a magnetic medium such as a hard disk, a floppy disk and a magnetic tape, an optical medium such as a CD-ROM and a DVD, a magneto-optical medium such as a floptical disk, and a hardware device specially configured to store and execute a program instruction such as ROM, RAM, and flash memory. An example of the program instruction includes a high-level language code to be executed by a computer using an interpreter or the like as well as a machine code generated by a compiler. The above hardware device may be configured to operate as at least one software module to perform the operations of the embodiments, and vise versa.

According to one embodiment of the present invention, the work is segmented into a plurality of zones, and the zones segmented on the work are assigned a plurality of workers to allow the workers to perform tasks for one work, so that the task can be rapidly performed.

According to one embodiment of the present invention, a task may be performed on an object having a part included in a specific zone and a remainder deviating from the specific zone based on a boundary rule, so that the worker performing task on a specific zone of the work can be prevented from missing a task on an object located over a plurality of boundaries of the work.

Although the above embodiments have been described with reference to the limited embodiments and drawings, however, it will be understood by those skilled in the art that various changes and modifications may be made from the above-mentioned description. For example, even though the described descriptions may be performed in an order different from the described manner, and/or the described components such as system, structure, device, and circuit may be coupled or combined in a form different from the described manner, or replaced or substituted by other components or equivalents, appropriate results may be achieved.

Therefore, other implementations, other embodiments, and equivalents to the claims are also within the scope of the following claims.

What is claimed is:

1. A method performed on a computing device including at least one processor and at least one memory to divide and provide work to workers in crowdsourcing, the method comprising:
a zone segmentation step of segmenting work including at least one unit task into a predetermined number of zones;
a graphic-processing step of graphic-processing a specific zone to be assigned to a worker in the work segmented into the predetermined number of zones so as to be displayed differently from other zones; and
a task interface providing step of providing a task interface including the work formed by graphic-processing the specific zone to a worker terminal of the worker, wherein the worker is allowed to select a task target area for an object through the worker terminal displaying the task interface, and
the selecting of the task target area includes:
selecting an area of the object completely included in the specific zone; and
selecting an area of the object having a part included in the specific zone and a remainder deviating from the specific zone in at least one direction according to a preset boundary rule.

2. The method of claim 1, wherein the work includes image data including at least one image object, and
the boundary rule includes:
selecting an area of the image object having a part included in the specific zone and a remainder deviating from the specific zone in a first direction of a horizontal axis of the image data;
selecting an area of the image object having a part included in the specific zone and
a remainder deviating from the specific zone in a first direction of a vertical axis of the image data; and
selecting an area of the image object having a part included in the specific zone and a remainder deviating from the specific zone in the first direction of the horizontal axis and the first direction of the vertical axis of the image data.

3. The method of claim 1, wherein the work includes audio data including at least one audio object,
the zone segmentation step includes segmenting the audio data into a predetermined number of zones according to a preset time interval, and
the graphic-processing step includes graphic-processing a specific area to be assigned to a worker so as to be displayed differently from other zones in a waveform of the audio data visually displayed on an axis of time.

4. The method of claim 1, wherein the work includes audio data including at least one audio object, and
the boundary rule includes:
selecting an area of the audio object having a part included in the specific zone and a remainder deviating from the specific zone in a first direction of the time axis of the audio data.

5. The method of claim 1, wherein the work includes text data including a plurality of unit texts, and
the boundary rule includes:
selecting an area of the unit texts having a part included in the specific zone and a remainder deviating from the specific zone in a text progression direction of the text data.

6. A computing device including at least one processor and at least one memory to perform a method for dividing and providing work to workers in crowdsourcing, the computing device performs:
a zone segmentation step of segmenting work including at least one unit task into a predetermined number of zones;
a graphic-processing step of graphic-processing a specific zone to be assigned to a worker in the work segmented into the predetermined number of zones so as to be displayed differently from other zones; and
a task interface providing step of providing a task interface including the work formed by graphic-processing the specific zone to a worker terminal of the worker, wherein
the worker is allowed to select a task target area for an object through the worker terminal displaying the task interface, and
the selecting of the task target area includes:
selecting an area of the object completely included in the specific zone; and
selecting an area of the object having a part included in the specific zone and a remainder deviating from the specific zone in at least one direction according to a preset boundary rule from the specific area.

7. A computer program stored on a computer-readable medium and including a plurality of instructions executed by at least one processor, the computer program comprises:
a zone segmentation step of segmenting work including at least one unit task into a predetermined number of zones;
a graphic-processing step of graphic-processing a specific zone to be assigned to a worker in the work segmented into the predetermined number of zones so as to be displayed differently from other zones; and
a task interface providing step of providing a task interface including the work formed by graphic-processing the specific zone to a worker terminal of the worker, wherein
the worker is allowed to select a task target area for an object through the worker terminal displaying the task interface, and
the selecting of the task target area includes:
selecting an area of the object completely included in the specific zone; and
selecting an area of the object having a part included in the specific zone and a remainder deviating from the specific zone in at least one direction according to a preset boundary rule from the specific area.
